(19) United States
(12) Patent Application Publication
(10) Pub. No.: US 2014/0287828 A1
(43) Pub. Date: Sep. 25, 2014

(54) UNLOCKING CONTENT IN A VIRTUAL ENVIRONMENT

(71) Applicant: ENVIE INTERACTIVE LLC, Venice, CA (US)

(72) Inventor: Viktor Kalvachev, Walnut Creek, CA (US)

(73) Assignee: ENVIE INTERACTIVE LLC, Venice, CA (US)

(21) Appl. No.: 14/295,259

(22) Filed: Jun. 3, 2014

Related U.S. Application Data
(63) Continuation of application No. 12/838,177, filed on Jul. 16, 2010.

(51) Int. Cl. A63F 13/00

(52) U.S. Cl. CPC A63F 13/00
USPC 463/29

(57) ABSTRACT

Content in a virtual environment may be unlocked based on an aggregated trust level. More specifically, trust levels of a user with individual ones of non-user characters in the virtual environment may be tracked. The trust levels may be based on interactions between the user and individual ones of non-user characters in the virtual environment. A group trust level of the user with a group of the non-user characters may be determined. The group trust level may be based on an aggregation of the trust levels of the individual ones of the non-user characters. Content that was previously locked for the user may be unlocked for the user responsive to the group trust level breaching a group trust threshold.

### FIELD OF THE INVENTION

The invention relates to unlocking content in a virtual environment based on an aggregated trust level.

### BACKGROUND OF THE INVENTION

Unlocking content, such as new episodes or levels, in virtual environments is known. Typically, such content is unlocked responsive to actions performed by a user. For example, unlockable content may be unlocked based on the quality of interactions between the user and an individual non-user character, such as when the user or the user's character in the virtual environment engages in and defeats a given non-user character in a contest in order to unlock a subsequent level.

### SUMMARY

One aspect of the invention relates to a system configured to provide a virtual environment in which content is unlocked based on an aggregated trust level, according to one or more implementations of the invention. More specifically, trust levels of a user with a plurality of non-user characters in the virtual environment may be tracked on an individual non-user character basis. The trust levels may be based on interactions between the user and individual ones of non-user characters in the virtual environment. The interactions may be tracked according to the quantity of the interactions, rather than quality of the interactions, in exemplary implementations. Quantity of interactions may describe the number of interactions, the duration of interactions, and/or other quantity metrics. A group trust level of the user with a group of the non-user characters may be determined. The group trust level may be based on an aggregation of the trust levels of individual ones of the non-user characters. Unlockable content that was previously locked for the user may be unlocked for the user responsive to the group trust level breaching a group trust threshold, in accordance with exemplary implementations.

In some implementations, the system may include one or more virtual environment servers and/or other components. The system may operate in communication and/or coordination with one or more external resources. Users may interface with the system and/or the external resources via client computing platforms. Components of the system, the virtual environment servers, the external resources, and/or the client computing platforms may be operatively linked via one or more electronic communication links. By way of non-limiting example, the given client computing platform may include one or more of a desktop computer, a laptop computer, a handheld computer, a NetBook, a Smartphone, and/or other computing platforms. The external resources may include sources of information, hosts and/or providers of virtual environments outside of the system, external entities participating with the system, and/or other resources.

The virtual environment servers may comprise electronic storage, one or more processors, and/or other components. The electronic storage may comprise electronic storage media that electronically stores information. The processor(s) may be configured to provide information processing capabilities in the virtual environments servers. The processor may be configured to execute one or more computer program modules. The one or more computer program modules may include one or more of an environment module, a non-user-character module, an activity module, a user-character module, an non-user-character-trust module, a group trust module, and/or other modules and/or sub-modules.

The environment module may be configured to provide one or more virtual environments to users via client computing platforms. As used herein, a “virtual environment” may include a virtual space, one or more interactive, electronic social media, and/or other virtual environments. The environment module may be configured to provide content to users within the virtual environment. The content may include views of the virtual environment. Some content may be identified as unlockable content. Examples of unlockable content may include levels, episodes, non-user characters, virtual goods, privileges in a virtual environment associated with a user and/or non-user character, capabilities in a virtual environment associated with a user and/or non-user character, and/or other unlockable content. As described further herein, the environment module may be configured to unlock, for a given user, content that was previously locked for the given user responsive to the given user achieving a group trust level with a group of non-user characters that breaches a threshold.

The non-user-character module may be configured to manage information related to one or more non-user characters within a virtual environment. The non-user characters for which information is managed by non-user-character module may include characters that are not controlled by users. The management of information by the non-user-character module may include storing non-user-character profiles that correspond to individual non-user characters to the electronic storage. The non-user-character profile corresponding to a given non-user character may include character information related to the given non-user character. The character information may include, for example, one or more of character progress information, character inventory information, character skill information, character appearance information, character relationship information, character activity preferences (see below), and/or other information. In some implementations, non-user characters may be grouped into one or more groups of non-user characters. As mentioned above, one or more non-user characters may be included as unlockable content.

In some implementations, the non-user-character module may include one or more non-user-character sub-modules (e.g., a first-non-user-character sub-module, a second-non-user-character sub-module, a third-non-user-character sub-module, a fourth-non-user-character sub-module, and/or other non-user-character sub-modules) associated with individual non-user characters. For example, a given non-user-character sub-module may be configured to manage information related to a given non-user character.

The activity module may be configured to manage information related to individual ones of a plurality of activities within the virtual environment. Examples of activities may include games (e.g., balderdash, sudoku, poker, gambling, slots, and/or other games), dancing, collecting, fashion, and/or other activities. The management of information by the activity module may include storing activity information that corresponds to individual activities to the electronic storage. The activity information may include, for example, one or more of rules, scoring parameters, scores, activity history, activity presentation information, activity relationship information, and/or other information. One or more activities may be included as unlockable content.

In some implementations, the activity module may include one or more activity sub-modules (e.g., a first-activity sub-module, a second-activity sub-module, a third-activity sub-module, a fourth-activity sub-module, and/or other activity sub-modules) associated with individual activities. For example, a given activity sub-module may be configured to manage information related to a given activity.

Individual ones of the non-user characters may be associated with different sets of the activities. Associations between non-user characters and activities and/or sets of activities may be indicated by information (e.g., character activity preferences) included in the non-user character profiles managed by non-user-character module (as described above). The associations between a non-user character and individual activities may be weighted according to the strengths of the associations between the non-user character and the different activities. A set of activities may include one or more of the plurality of activities. Different sets of the activities may include one or more similar activities and/or one or more different activities. Interactions between a given user and a given non-user character may include participation by the given user with the given non-user character in an activity associated with the given non-user character. In some implementations, interactions may involve one or more users and/or one or more non-user characters.

The user-character module may be configured to manage information related to user characters associated with users within the virtual environment. This may include information related to the user character associated with the first user. In accordance with some implementations, a user character may include an avatar associated with a user. A user character for which information is managed by the user-character module may include a user character that is controlled a user. The management of information by user-character module may include storing character profiles that correspond to individual user-characters to the electronic storage. The character profile corresponding to a given user character may include character information related to the given user character. The user character information may include, for example, one or more of user information, character progress information, character inventory information, character skill information, character appearance information, character relationship information, and/or other information. According to some implementations, the user character information may include, for example, friend information (e.g., information related to friends of a user), virtual environment usage information, demographic information associated with users, interaction history among users in one or more virtual environments and/or other environments, information stated by users, purchase information of users, browsing history of users, and/or other information related to users. In some implementations, participation by a given user with a given non-user character in one or more activities associated with the given non-user character may include participation by the user character associated with the given user with the given non-user character in one or more activities associated with the given non-user character.

The non-user-character-trust module may be configured to track trust levels of users and/or user characters with individual ones of the non-user characters. The trust level of a given user or user character with a given non-user character may be based, at least in part, on interactions between the given user or user character and the given non-user character. The trust levels may be based on interactions between the user or user character and individual ones of non-user characters in the virtual environment. The interactions may be tracked according to the quantity of the interactions, rather than quality of the interactions, in exemplary implementations. Quantity of interactions may describe the number of interactions, the duration of interactions, and/or other quantity metrics. In one implementation, a trust level associated with a given user and a given non-user character is tracked based, at least in part, on the amount of time the given user spends participating in one or more activities associated with the given non-user character. According to some implementations, a trust level associated with a given user and a given non-user character is tracked based, at least in part, on the number of times the given user participates in one or more activities associated with the given non-user character. In some implementations, some activities associated with a given non-user character are weighted differently from other activities associated with the given non-user character such that a trust level associated with a given user and the given non-user character may increase more rapidly when the given user participates in activities that are more heavily weighted relative to other activities associated with the given non-user character. Some non-user characters may have a stronger association with a given user such that interactions by the given user with those non-user characters may result in a more rapid increase in associated trust levels relative to interactions with non-user characters having a weaker association with the given user.

The non-user-character-trust module may be configured to manage one or more thresholds associated with trust levels of users with individual ones of the non-user characters. When a given threshold associated with a given trust level is breached, unlockable content may be unlocked for a user, one or more non-user characters may be prompted to perform an action, and/or other actions may be performed by one or more modules and/or sub-modules in the virtual environment. For example, in some implementations, the non-user character module may be configured to provide, to a user, a privilege associated with a given non-user character in the virtual environment responsive to the trust level associated with the given non-user character breaching a privilege threshold. A privilege may include a special relationship status, access to privileged information, ability to participate in certain activities and/or events, access to and/or ability to obtain items or objects in the game, introduction to new characters, training for a new ability and/or increased aptitude in an existing ability, and/or other privileges. In accordance with some implementations, the non-user character module may be configured to prompt a given non-user character to provide a virtual item to a user responsive to the trust level associated with the given non-user character breaching a gifting threshold. A virtual item may include a virtual good and/or other virtual items.

In some implementations, the non-user-character-trust module may include one or more activity sub-modules (e.g., a first-non-user-character-trust sub-module, a second-non-user-character-trust sub-module, a third-non-user-character-trust sub-module, a fourth-non-user-character-trust sub-module, and/or other non-user-character-trust sub-modules) associated with individual non-user characters. For example, a given non-user-character-trust sub-module may be configured to track a trust level between a user and a given non-user character.

The group trust module may be configured to determine group trust levels of users with individual ones of one or more groups of non-user characters. In exemplary implementations a group trust level of a given user with a given group of non-user characters may be based, at least in part, on an aggregation of the trust levels of the given user with the constituent non-user characters of the given group of non-user characters. In one implementation, the group trust module is configured such that the aggregation of the trust levels includes a summation of the trust levels. Other aggregation techniques are contemplated, and are within the scope of the present invention. For example, interactions involving some activities may be weighted differently than interactions involving other activities while aggregating trust levels.

The group trust module may be configured to manage one or more group trust thresholds associated with group trust levels of users with individual groups of non-user characters. When a given threshold associated with a given group trust level is breached, unlockable content may be unlocked for a user, one or more non-user characters may be prompted to perform an action, and/or other actions may be performed by one or more modules and/or sub-modules in the virtual environment. For example, in some implementations, the non-user character module may be configured to unlock a new non-user character in the virtual environment responsive to the group trust level breaching a given group trust threshold. Information related to such a new non-user character may be managed by the non-user character module. In some implementations, content of the virtual environment may include a plurality of episodes, wherein a user is presented one episode at a time. An episode that has not previously been presented by the environment module to a given user may be unlocked responsive to the group trust level breaching a given group trust threshold. In some implementations, the non-user character module may be configured to provide, to a user, a privilege associated with one or more non-user characters in the virtual environment responsive to the group trust level associated with a given group of non-user characters breaching a given group trust threshold. As mentioned above, a privilege may include a special relationship status, access to privileged information, ability to participate in certain activities and/or events, access to and/or ability to obtain items or objects in the game, introduction to new characters, training for a new ability and/or increased aptitude in an existing ability, and/or other privileges. In accordance with some implementations, the non-user character module may be configured to prompt one or more non-user characters to provide one or more virtual items to a user responsive to the group trust level associated with a given group of non-user characters breaching a given group trust threshold.

Another aspect of the invention relates to a method for unlocking content in a virtual environment based on an aggregated trust level, according to one or more implementations of the invention. At one operation, content is provided to a first user within a virtual environment. The content may include views of the virtual environment. The content may include non-user characters and/or a plurality of activities within the virtual environment. In some implementations, the non-user characters may be grouped into one or more groups. Individual ones of the non-user characters may be associated with different sets of the activities. Interactions between the first user and a first non-user character may include participation by the first user with the first non-user character in an activity in a set of the activities associated with the first non-user character. In some implementations, this operation may be performed through execution of the environment module.

At another operation, activities associated with non-user characters and interactions between the first user and the non-user characters are monitored. The interactions may include participation by the first user in one or more of the monitored activities. According to exemplary implementations this operation may be performed through execution of the activity module.

At another operation, trust levels of the first user with individual ones of the non-user characters are tracked. The trust level of the first user with the first non-user character may be based on interactions between the first user and the first non-user character. The non-user-character module may be executed to perform this operation, in accordance with some implementations.

At another operation, group trust levels of the users with individual ones of the one or more groups of the non-user characters are determined. A group trust level of the first user with a first group of non-user characters including the first non-user character may be based, at least in part, on an aggregation of the trust level of the first user with the first non-user character and the trust levels of the first user with the other non-user characters in the first group of non-user characters. This operation may be performed by way of execution of the group trust module, in some implementations.

At another operation, a determination is made as to whether a group trust level breaches a group trust threshold. Responsive to a negative determination, the method may return to the operation in which activities associated with non-user characters and interactions between the first user and the non-user characters are monitored. Responsive to a positive determination, the method may proceed to the operation that follows below. In some implementations, this operation may be performed through execution of the group trust module.

At another operation, content that was previously locked for the first user is unlocked for the first user responsive to the first user achieving a group trust level with the first group of non-user characters that breaches a first group trust threshold. According to some implementations, the environment module may be executed to perform this operation.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured to provide a virtual environment in which content is unlocked based on an aggregated trust level, according to one or more implementations of the invention.

FIG. 2 illustrates information that may be utilized by the system of FIG. 1, according to one or more implementations of the invention.

FIG. 3 illustrates a method for unlocking content in a virtual environment based on an aggregated trust level, according to one or more implementations of the invention.

### DETAILED DESCRIPTION

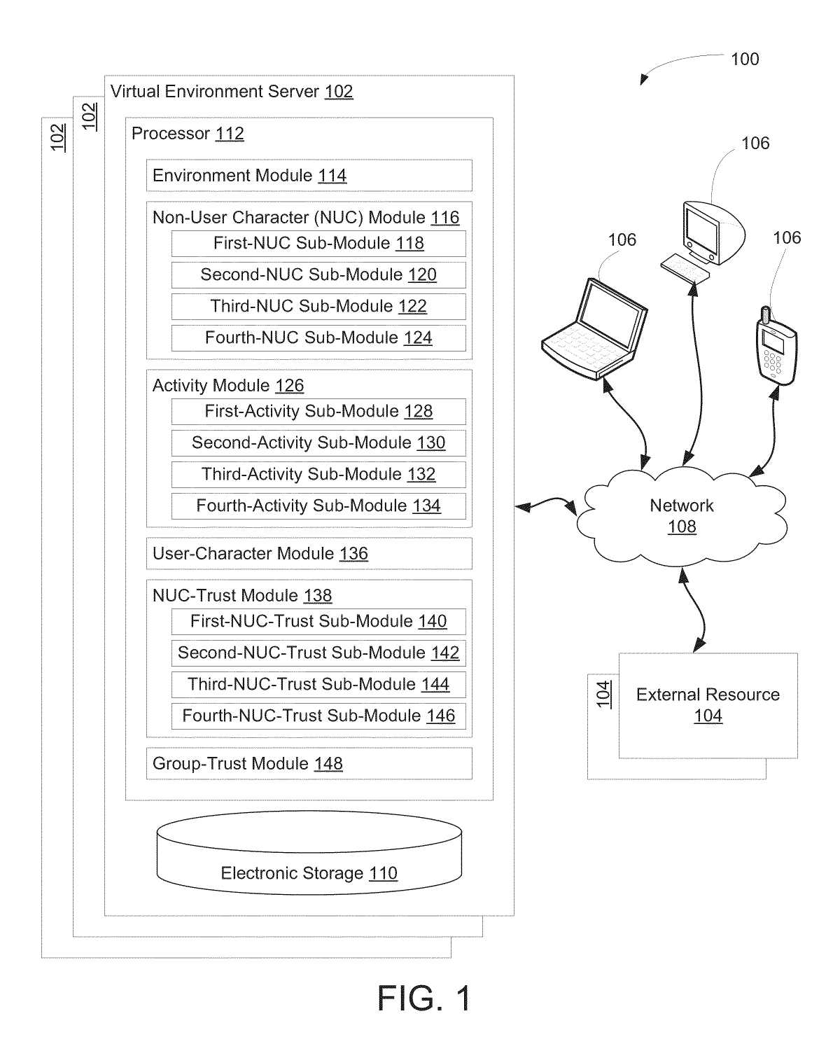

FIG. 1 illustrates a system 100 configured to provide a virtual environment in which content is unlocked based on an aggregated trust level, according to one or more implementations of the invention. More specifically, trust levels of a user with a plurality of non-user characters in the virtual environment may be tracked on an individual non-user character basis. The trust levels may be based on interactions between the user and individual ones of non-user characters in the virtual environment. The interactions may be tracked according to the quantity of the interactions, rather than quality of the interactions, in exemplary implementations. Quantity of interactions may describe the number of interactions, the duration of interactions, and/or other quantity metrics. A group trust level of the user with a group of the non-user characters may be determined. The group trust level may be based on an aggregation of the trust levels of individual ones of the non-user characters. Unlockable content that was previously locked for the user may be unlocked for the user responsive to the group trust level breaching a group trust threshold, in accordance with exemplary implementations.

In some implementations, the system 100 may include one or more virtual environment servers 102 and/or other components. The system 100 may operate in communication and/or coordination with one or more external resources 104. Users may interface with the system 100 and/or the external resources 104 via client computing platforms 106. Components of the system 100, the virtual environment servers 102, the external resources 104, and/or the client computing platforms 106 may be operatively linked via one or more electronic communication links. For example, such electronic communication links may be established, at least in part, via a network 108, which may include the Internet and/or other networks. It will be appreciated that this is not intended to be limiting, and that the scope of this disclosure includes implementations in which the virtual environment servers 102, the external resources 104, and/or the client computing platforms 106 are operatively linked via some other communication media.

A given client computing platform 106 may include one or more processors configured to execute computer program modules. The computer program modules may be configured to enable one or more users associated with the given client computing platform 106 to interface with the system 100 and/or the external resources 104, and/or provide other functionality attributed herein to client computing platforms 106. By way of non-limiting example, the given client computing platform 106 may include one or more of a desktop computer, a laptop computer, a handheld computer, a NetBook, a Smartphone, and/or other computing platforms.

The external resources 104 may include sources of information, hosts and/or providers of virtual environments outside of the system 100, external entities participating with the system 100, and/or other resources. In some implementations, some or all of the functionality attributed herein to the external resources 104 may be provided by resources included in the system 100.

The virtual environment servers 102 may comprise electronic storage 110, one or more processors 112, and/or other components. The virtual environment servers 102 may include communication lines, or ports to enable the exchange of information with a network and/or other computing platforms. Although system 100 may be described in certain sections herein as including virtual environment servers 102, this is not intended to be limiting. The virtual environment servers 102 may be separate and distinct from the system 100, and may be provided by an entity that is separate from, for example, one or more components of the system 100.

The electronic storage 110 may comprise electronic storage media that electronically stores information. The electronic storage media of the electronic storage 110 may include one or both of system storage that is provided integrally (i.e., substantially non-removable) with the virtual environment servers 102 and/or removable storage that is removably connectable to the virtual environment servers 102 via, for example, a port (e.g., a USB port, a firewire port, etc.) or a drive (e.g., a disk drive, etc.). The electronic storage 110 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage 110 may store software algorithms, information determined by processors 112, information received from client computing platforms 106, information received from the external resources 104, and/or other information that enables the virtual environment servers 102 to function as described herein.

The processor(s) 112 may be configured to provide information processing capabilities in the virtual environments servers 102. As such, the processor 112 may include one or more of a digital processor, an analog processor, a digital circuit designed to process information, an analog circuit designed to process information, a state machine, and/or other mechanisms for electronically processing information. Although the processor 112 is shown in FIG. 1 as a single entity, this is for illustrative purposes only. In some implementations, processor 112 may include a plurality of processing units. These processing units may be physically located within the same device, or the processor 112 may represent processing functionality of a plurality of devices operating in coordination.

As is shown in FIG. 1, the processor 112 may be configured to execute one or more computer program modules. The one or more computer program modules may include one or more of an environment module 114, a non-user-character module 116, an activity module 126, a user-character module 136, an non-user-character-trust module 138, a group trust module 148, and/or other modules and/or sub-modules. The processor 112 may be configured to execute modules 114, 116, 126, 136, 138, and/or 148 by software; hardware; firmware; some combination of software, hardware, and/or firmware; and/or other mechanisms for configuring processing capabilities on the processor 112.

It should be appreciated that although modules 114, 116, 126, 136, 138, and 148 are illustrated in FIG. 1 as being co-located within a single processing unit, in implementations in which the processor 112 includes multiple processing units, one or more of modules 114, 116, 126, 136, 138, and/or 148 may be located remotely from the other modules. The description of the functionality provided by the different modules 114, 116, 126, 136, 138, and/or 148 described below is for illustrative purposes, and is not intended to be limiting, as any of modules 114, 116, 126, 136, 138, and/or 148 may provide more or less functionality than is described. For example, one or more of modules 114, 116, 126, 136, 138, and/or 148 may be eliminated, and some or all of its functionality may be provided by other ones of modules 114, 116, 126, 136, 138, and/or 148. As another example, processor 112 may be configured to execute one or more additional modules that may perform some or all of the functionality attributed below to one of modules 114, 116, 126, 136, 138, and/or 148.

The environment module 114 may be configured to provide one or more virtual environments to users via client computing platforms 106. As used herein, a “virtual environment” may include a virtual space, one or more interactive, electronic social media, and/or other virtual environments. The environment module 114 may be configured to provide content to users within the virtual environment. The content may include views of the virtual environment. Some content may be identified as unlockable content. Examples of unlockable content may include levels, episodes, non-user characters, virtual goods, privileges in a virtual environment associated with a user and/or non-user character, capabilities in a virtual environment associated with a user and/or non-user character, and/or other unlockable content. As described further herein, the environment module 114 may be configured to unlock, for a given user, content that was previously locked for the given user responsive to the given user achieving a group trust level with a group of non-user characters that breaches a threshold.

A virtual space may comprise a simulated space (e.g., a physical space) instanced on a server (e.g., the virtual environment servers 102) that is accessible by a client (e.g., the client computing platforms 106) located remotely from the server to format a view of the virtual space for display to a user. The simulated space may have a topography, express ongoing real-time interaction by the user, and/or include one or more objects positioned within the topography that are capable of locomotion within the topography. In some instances, the topography may be a 2-dimensional topography. In other instances, the topography may be a 3-dimensional topography. The topography may include dimensions of the virtual space, and/or surface features of a surface or objects that are “native” to the virtual space. In some instances, the topography may describe a surface (e.g., a ground surface) that runs through at least a substantial portion of the virtual space. In some instances, the topography may describe a volume with one or more bodies positioned therein (e.g., a simulation of gravity-deprived space with one or more celestial bodies positioned therein). A virtual space may include a virtual world, but this is not necessarily the case. For example, a virtual space may include a game space that does not include one or more of the aspects generally associated with a virtual world (e.g., gravity, a landscape, etc.).

Virtual goods may be non-physical objects that can be purchased for use in online communities, online games, virtual worlds, and other virtual spaces. Virtual goods may include, for example, such things as digital gifts, digital clothing for avatars, virtual real estate, and/or any other virtual item. Virtual goods may be classified as services (i.e., virtual services) instead of goods. Sales of virtual goods may be referred to as microtransactions.

Interactive, electronic social media may include one or more of a social network, a virtual space, a micro-blogging service, a blog service (or host), a browser-based game, a multi-player mobile game, a file (e.g., image file, video file, and/or other files) sharing service, a messaging service, a message board, a forum, and/or other electronically distributed media that are scalable and enable interaction between the users. Some non-limiting specific examples of interactive, electronic social media may include the micro-blogging service provided by Twitter™, the social network provided by Facebook™, the social network provided by MySpace™, the virtual world provided by SecondLife®, the virtual world building and hosting service provided by Metaplace®, the massively multi-player online game provided by World of Warcraft®, the file sharing service provided by Flickr, Blogger, YouTube, PlayStation® Home, Xbox® Live, and/or other interactive electronic social media.

The environment module 114 may be configured such that the virtual environment is at least partially text-based. In such implementations, the environment module 114 may generate text and/or static graphics that convey to users activities currently transpiring within the virtual environment. Within this type of virtual environment, a user may be able to interact with other users, and/or the text and/or static graphics generated by the environment module 114 may convey activities of other users within the virtual environment. This type of virtual environment may be asynchronous so that the user may be isolated within the virtual environment from other users (e.g., a different instance may be implemented for each user).

The non-user-character module 116 may be configured to manage information related to one or more non-user characters within a virtual environment. The non-user characters for which information is managed by non-user-character module 116 may include characters that are not controlled by users. The management of information by the non-user-character module 116 may include storing non-user-character profiles that correspond to individual non-user characters to the electronic storage 110. The non-user-character profile corresponding to a given non-user character may include character information related to the given non-user character. The character information may include, for example, one or more of character progress information, character inventory information, character skill information, character appearance information, character relationship information, character activity preferences (see below), and/or other information. In some implementations, non-user characters may be grouped into one or more groups of non-user characters. As mentioned above, one or more non-user characters may be included as unlockable content.

The non-user-character module 116 may include one or more artificial intelligence engines that are used to control the non-user-characters within the game. This may include separate artificial intelligence engines for separate types of non-user-characters, and/or separate artificial intelligence engines for separate non-user-characters. In some implementations, a single artificial intelligence engine may be used to control a plurality of non-user-characters, with one or more aspects of the single artificial intelligence engine being adjusted based on parameters included in the non-user-character profiles managed by the non-user-character module 116. For example, a non-user-character profile may include values for one or more personality traits, one or more faction allegiances, one or more friendships, and/or other parameters. The artificial intelligence engine used to control the non-user-character corresponding to the non-user-character profile may be adjusted based on the parameters. Other exemplary implementations of artificial intelligence control are contemplated.

In some implementations, one or more of the non-user-characters may be controlled according to a script, rather than and/or along with an artificial intelligence engine. The script may dictate the specific response of the non-user-character to certain circumstances, actions by the user, and/or other stimulus within the videogame. The scripts for the individual non-user-characters may be included in the non-user-character profiles managed by the non-user-character module 116. As one potential alternative, the non-user-character profiles may include references to one or more scripts that should be used to control the corresponding non-user-characters, rather than the actual scripts.

In some implementations, the non-user-character module 116 may include one or more non-user-character sub-modules (e.g., a first-non-user-character sub-module 118, a second-non-user-character sub-module 120, a third-non-user-character sub-module 122, a fourth-non-user-character sub-module 124, and/or other non-user-character sub-modules) associated with individual non-user characters. For example, a given non-user-character sub-module may be configured to manage information related to a given non-user character. It is appreciated that, while the non-user-character module 116 is depicted in FIG. 1 as including the first-non-user-character sub-module 118, the second-non-user-character sub-module 120, the third-non-user-character sub-module 122, and the fourth-non-user-character sub-module 124, the non-user-character module 116 may include any number of non-user-character sub-modules.

The activity module 126 may be configured to manage information related to individual ones of a plurality of activities within the virtual environment. Examples of activities may include games (e.g., balderdash, sudoku, poker, gambling, slots, and/or other games), dancing, collecting, fashion, and/or other activities. The management of information by the activity module 126 may include storing activity information that corresponds to individual activities to the electronic storage 110. The activity information may include, for example, one or more of rules, scoring parameters, scores, activity history, activity presentation information, activity relationship information, and/or other information. One or more activities may be included as unlockable content.

Individual ones of the non-user characters may be associated with different sets of the activities. Associations between non-user characters and activities and/or sets of activities may be indicated by information (e.g., character activity preferences) included in the non-user character profiles managed by non-user-character module 116 (as described above). The associations between a non-user character and individual activities may be weighted according to the strengths of the associations between the non-user character and the different activities. A set of activities may include one or more of the plurality of activities. Different sets of the activities may include one or more similar activities and/or one or more different activities. Interactions between a given user and a given non-user character may include participation by the given user with the given non-user character in an activity associated with the given non-user character. In some implementations, interactions may involve one or more users and/or one or more non-user characters.

In some implementations, the activity module 126 may include one or more activity sub-modules (e.g., a first-activity sub-module 128, a second-activity sub-module 130, a third-activity sub-module 132, a fourth-activity sub-module 134, and/or other activity sub-modules) associated with individual activities. For example, a given activity sub-module may be configured to manage information related to a given activity. It is appreciated that, while the activity module 126 is depicted in FIG. 1 as including the first-activity sub-module 128, the second-activity sub-module 130, the third-activity sub-module 132, and the fourth-activity sub-module 134, the activity module 126 may include any number of activity sub-modules.

The user-character module 136 may be configured to manage information related to user characters associated with users within the virtual environment. This may include information related to the user character associated with the first user. A user character for which information is managed by the user-character module 136 may include a user character that is controlled a user. The management of information by user-character module 136 may include storing character profiles that correspond to individual user-characters to the electronic storage 110. The character profile corresponding to a given user character may include character information related to the given user character. The user character information may include, for example, one or more of user information, character progress information, character inventory information, character skill information, character appearance information, character relationship information, and/or other information. According to some implementations, the user character information may include, for example, friend information (e.g., information related to friends of a user), virtual environment usage information, demographic information associated with users, interaction history among users in one or more virtual environments and/or other environments, information stated by users, purchase information of users, browsing history of users, and/or other information related to users. In some implementations, participation by a given user with a given non-user character in one or more activities associated with the given non-user character may include participation by the user character associated with the given user with the given non-user character in one or more activities associated with the given non-user character.

In accordance with some implementations, a user character may include an avatar associated with a user. Within a virtual space provided by virtual environment servers 102, avatars associated with users may be controlled by the users to interact with other users and/or non-user characters. As used herein, the term “avatar” may refer to an object (or group of objects) present in the virtual space that represents an individual user. The avatar may be controlled by the user with which it is associated. The avatars may interact with non-user characters by physical interaction within the instanced virtual environment, through participation in one or more activities, text chat, voice chat, and/or other interactions. The avatar associated with a given user may be created and/or customized by the given user. The avatar may be associated with an “inventory” of virtual goods and/or currency that the user can use (e.g., by manipulation of the avatar and/or the items) within the virtual space.

The non-user-character-trust module 138 may be configured to track trust levels of users and/or user characters with individual ones of the non-user characters. The trust level of a given user or user character with a given non-user character may be based, at least in part, on interactions between the given user or user character and the given non-user character. The trust levels may be based on interactions between the user or user character and individual ones of non-user characters in the virtual environment. The interactions may be tracked according to the quantity of the interactions, rather than quality of the interactions, in exemplary implementations. Quantity of interactions may describe the number of interactions, the duration of interactions, and/or other quantity metrics. In one implementation, a trust level associated with a given user and a given non-user character is tracked based, at least in part, on the amount of time the given user spends participating in one or more activities associated with the given non-user character. According to some implementations, a trust level associated with a given user and a given non-user character is tracked based, at least in part, on the number of times the given user participates in one or more activities associated with the given non-user character. In some implementations, some activities associated with a given non-user character are weighted differently from other activities associated with the given non-user character such that a trust level associated with a given user and the given non-user character may increase more rapidly when the given user participates in activities that are more heavily weighted relative to other activities associated with the given non-user character. Some non-user characters may have a stronger association with a given user such that interactions by the given user with those non-user characters may result in a more rapid increase in associated trust levels relative to interactions with non-user characters having a weaker association with the given user.

The non-user-character-trust module 138 may be configured to manage one or more thresholds associated with trust levels of users with individual ones of the non-user characters. When a given threshold associated with a given trust level is breached, unlockable content may be unlocked for a user, one or more non-user characters may be prompted to perform an action, and/or other actions may be performed by one or more modules and/or sub-modules in the virtual environment. For example, in some implementations, the non-user character module 138 may be configured to provide, to a user, a privilege associated with a given non-user character in the virtual environment responsive to the trust level associated with the given non-user character breaching a privilege threshold. A privilege may include a special relationship status, access to privileged information, ability to participate in certain activities and/or events, access to and/or ability to obtain items or objects in the game, introduction to new characters, training for a new ability and/or increased aptitude in an existing ability, and/or other privileges. In accordance with some implementations, the non-user character module 138 may be configured to prompt a given non-user character to provide a virtual item to a user responsive to the trust level associated with the given non-user character breaching a gifting threshold. A virtual item may include a virtual good and/or other virtual items.

In some implementations, the non-user-character-trust module 138 may include one or more activity sub-modules (e.g., a first-non-user-character-trust sub-module 140, a second-non-user-character-trust sub-module 142, a third-non-user-character-trust sub-module 144, a fourth-non-user-character-trust sub-module 146, and/or other non-user-character-trust sub-modules) associated with individual non-user characters. For example, a given non-user-character-trust sub-module may be configured to track a trust level between a user and a given non-user character. It is appreciated that, while the non-user-character-trust module 138 is depicted in FIG. 1 as including the first-non-user-character-trust sub-module 140, the second-non-user-character-trust sub-module 142, the third-non-user-character-trust sub-module 144, and the fourth-non-user-character-trust sub-module 146, the non-user-character-trust module may include any number of non-user-character-trust sub-modules.

The group trust module 148 may be configured to determine group trust levels of users with individual ones of one or more groups of non-user characters. In exemplary implementations a group trust level of a given user with a given group of non-user characters may be based, at least in part, on an aggregation of the trust levels of the given user with the constituent non-user characters of the given group of non-user characters. In one implementation, the group trust module 148 is configured such that the aggregation of the trust levels includes a summation of the trust levels. Other aggregation techniques are contemplated, and are within the scope of the present invention. For example, interactions involving some activities may be weighted differently than interactions involving other activities while aggregating trust levels.

The group trust module 148 may be configured to manage one or more group trust thresholds associated with group trust levels of users with individual groups of non-user characters. When a given threshold associated with a given group trust level is breached, unlockable content may be unlocked for a user, one or more non-user characters may be prompted to perform an action, and/or other actions may be performed by one or more modules and/or sub-modules in the virtual environment. For example, in some implementations, the non-user character module 138 may be configured to unlock a new non-user character in the virtual environment responsive to the group trust level breaching a given group trust threshold. Information related to such a new non-user character may be managed by the non-user character module 138. In some implementations, content of the virtual environment may include a plurality of episodes, wherein a user is presented one episode at a time. An episode that has not previously been presented by the environment module 114 to a given user may be unlocked responsive to the group trust level breaching a given group trust threshold. In some implementations, the non-user character module 138 may be configured to provide, to a user, a privilege associated with one or more non-user characters in the virtual environment responsive to the group trust level associated with a given group of non-user characters breaching a given group trust threshold. As mentioned above, a privilege may include a special relationship status, access to privileged information, ability to participate in certain activities and/or events, access to and/or ability to obtain items or objects in the game, introduction to new characters, training for a new ability and/or increased aptitude in an existing ability, and/or other privileges. In accordance with some implementations, the non-user character module 138 may be configured to prompt one or more non-user characters to provide one or more virtual items to a user responsive to the group trust level associated with a given group of non-user characters breaching a given group trust threshold.

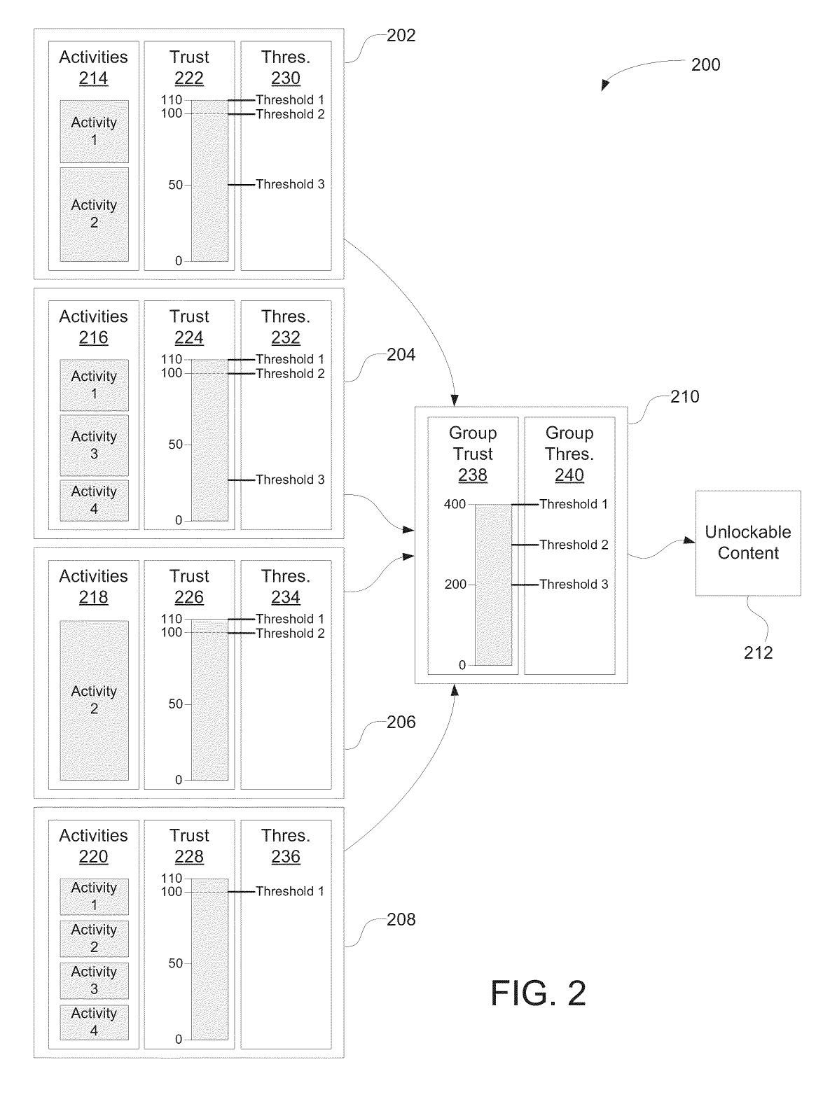

FIG. 2 illustrates information 200 that may be utilized by the system 100, according to one or more implementations of the invention. From the following description, it will be appreciated that the depiction of the information 200 in FIG. 2 is not a view of a game, but instead is a schematic representation conceptually illustrating how participation in activities within the game by a user character with non-user characters may be used to unlock content for the user character in the game. The information 200 may be represented by panel 202, panel 204, panel 206, panel 208, panel 210, panel 212, and/or other panels. The representation of the information 200 by the panels 202-212 is illustrative, and not intended to be limiting as the information 200 may be represented in any number of manners. The information described in connection with individual ones of the panels 202-212 may be managed by one or more modules and/or sub-modules described herein in connection with the processor 112.

The panels 202-208 may represent information associated with individual non-user characters. For example, the panel 202 may represent information associated with a first-non-user character, the panel 204 may represent information associated with a second-non-user character, the panel 206 may represent information associated with a third-non-user character, and the panel 208 may represent information associated with a fourth-non-user character. The first-non-user character, the second-non-user character, the third-non-user character, and the fourth-non-user character may be grouped into a group of non-user characters.

Information represented by individual ones of the panels 202-208 may include activity information associated with individual non-user characters (e.g., activity information 214, activity information 216, activity information 218, activity information 220, and/or other activity information), trust-level information associated with individual non-user characters (e.g., trust-level information 222, trust-level information 224, trust-level information 226, trust-level information 228, and/or other trust-level information), threshold information associated with individual non-user characters (e.g., threshold information 230, threshold information 232, threshold information 234, threshold information 236, and/or other threshold information), and/or other information.

The activity information associated with individual non-user characters may indicate which particular activities are associated with individual ones of the first-non-user character, the second-non-user character, the third-non-user character, and the fourth-non-user character. More specifically, the activity information 214 may indicate that the first-non-user character is associated with a first activity and a second activity; the activity information 216 may indicate that the second-non-user character is associated with the first activity, a third activity, and a fourth activity; the activity information 218 may indicate that the third-non-user character is associated with the second activity; and the activity information 214 may indicate that the fourth-non-user character is associated with the first activity, the second activity, the third activity, and the fourth activity.

The trust-level information associated with individual non-user characters may indicate trust levels between the user and individual ones of the first-non-user character, the second-non-user character, the third-non-user character, and the fourth-non-user character. More specifically, the trust-level information 222 may indicate a trust level between the user and the first-non-user character, the trust-level information 224 may indicate a trust level between the user and the second-non-user character, the trust-level information 226 may indicate may indicate a trust level between the user and the third-non-user character, and the trust-level information 228 may indicate may indicate a trust level between the user and the fourth-non-user character. The trust level associated with a given non-user character may increase as the user participates with the given non-user character in one or more activities associated with the given non-user character. Although the trust-level information 222-228 are depicted as bar meters ranging from zero to one hundred ten, the trust-level information 222-228 may represent trust levels in other quantitative representations (e.g., an single numerical value, and/or other quantitative representations) and qualitative representations (e.g., a range of stars and/or other qualitative representations).

The threshold information associated with individual non-user characters may indicate one or more trust levels associated with individual ones of the first-non-user character, the second-non-user character, the third-non-user character, and the fourth-non-user character. More specifically, the threshold information 230 may indicate one or more thresholds associated with the first-non-user character, the threshold information 232 may indicate one or more thresholds associated with the second-non-user character, the threshold information 234 may indicate one or more thresholds associated with the third-non-user character, and the threshold information 236 may indicate one or more thresholds associated with the fourth-non-user character. When the trust level associated with a given non-user character breaches a threshold associated with the given non-user character, the given non-user character may be prompted to perform an action and/or other actions may be performed by one or more modules and/or sub-modules in the virtual environment.

The panel 210 may represent information associated with the group of non-user characters that includes the first-non-user character, the second-non-user character, the third-non-user character, and the fourth-non-user character. The information associated with the group of non-user characters may include group trust information 238, group threshold information 240, and/or other information.

The group trust information 238 may include a group trust level associated with the group of non-user characters that includes the first-non-user character, the second-non-user character, the third-non-user character, and the fourth-non-user character. The group trust level may be determined by aggregating the individual trust levels associated with the first-non-user character, the second-non-user character, the third-non-user character, and the fourth-non-user character, as depicted in FIG. 2 by trust-level information 222-228.

The group threshold information 240 may include one or more group thresholds associated with the group of non-user characters that includes the first-non-user character, the second-non-user character, the third-non-user character, and the fourth-non-user character. Individual ones of the one or more group thresholds may be associated with various unlockable content, such that when a given group threshold is breached the unlockable content associated with the given group threshold is unlocked for the user in the virtual environment.

The panel 212 may represent unlockable content that may be unlocked responsive to a trust level associated with an individual non-user character breaching a threshold and/or a group trust level associated with a group of non-user characters breaching a group threshold. Examples of unlockable content may include levels, episodes, non-user characters, virtual goods, privileges (see, e.g., above) in a virtual environment associated with a user and/or non-user character, capabilities in a virtual environment associated with a user and/or non-user character, and/or other unlockable content.

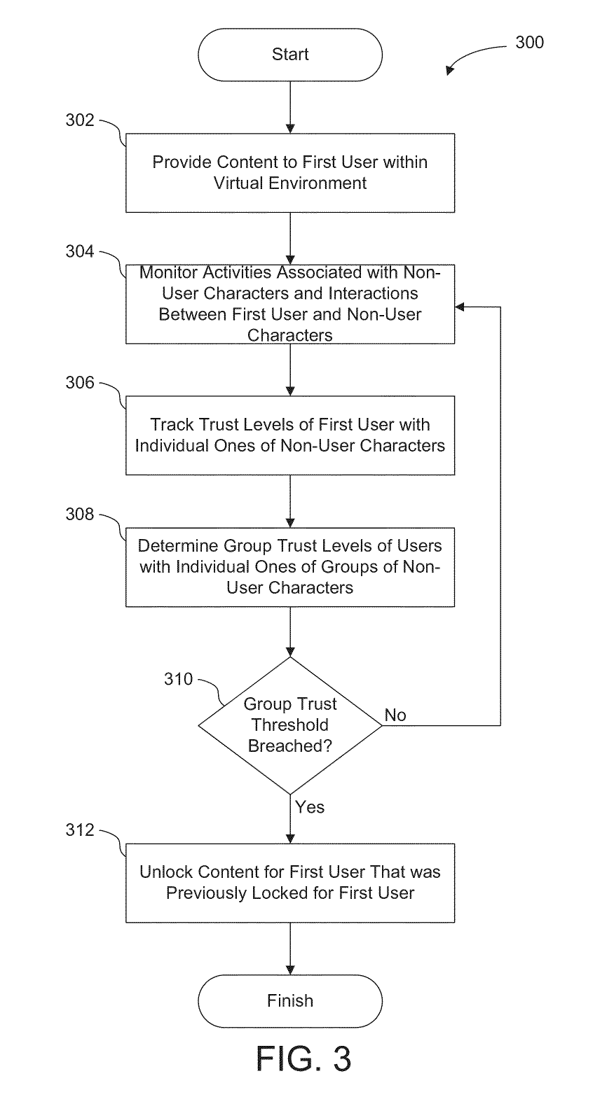

FIG. 3 illustrates a method 300 for unlocking content in a virtual environment based on an aggregated trust level, according to one or more implementations of the invention. The operations of the method 300 presented below are intended to be illustrative. In some implementations, the method 300 may be accomplished with one or more additional operations not described, and/or without one or more of the operations discussed. Additionally, the order in which the operations of the method 300 are illustrated in FIG. 3 and described below is not intended to be limiting.

In some implementations, the method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of the method 300 in response to instructions stored electronically on an electronic storage medium. The one or more processing devices may include one or more devices configured through hardware, firmware, and/or software to be specifically designed for execution of one or more of the operations of the method 300.

At an operation 302, content is provided to a first user within a virtual environment. The content may include views of the virtual environment. The content may include non-user characters and/or a plurality of activities within the virtual environment. In some implementations, the non-user characters may be grouped into one or more groups. Individual ones of the non-user characters may be associated with different sets of the activities. Interactions between the first user and a first non-user character may include participation by the first user with the first non-user character in an activity in a set of the activities associated with the first non-user character. In some implementations, the operation 302 may be performed through execution of the environment module 114.

At an operation 304, activities associated with non-user characters and interactions between the first user and the non-user characters are monitored. The interactions may include participation by the first user in one or more of the monitored activities. According to exemplary implementations the operation 304 may be performed through execution of the activity module 126.

At an operation 306, trust levels of the first user with individual ones of the non-user characters are tracked. The trust level of the first user with the first non-user character may be based on interactions between the first user and the first non-user character. The non-user-character module 116 may be executed to perform the operation 306, in accordance with some implementations.

At an operation 308, group trust levels of the users with individual ones of the one or more groups of the non-user characters are determined. A group trust level of the first user with a first group of non-user characters including the first non-user character may be based, at least in part, on an aggregation of the trust level of the first user with the first non-user character and the trust levels of the first user with the other non-user characters in the first group of non-user characters. The operation 308 may be performed by way of execution of the group trust module 148, in some implementations.

At an operation 310, a determination is made as to whether a group trust level breaches a group trust threshold. Responsive to a negative determination, the method 300 may return to the operation 304. Responsive to a positive determination, the method 300 may proceed to an operation 312. In some implementations, the operation 310 may be performed through execution of the group trust module 148.

At the operation 312, content that was previously locked for the first user is unlocked for the first user responsive to the first user achieving a group trust level with the first group of non-user characters that breaches a first group trust threshold. According to some implementations, the environment module 114 may be executed to perform the operation 312.

Although the invention has been described in detail for the purpose of illustration based on what is currently considered to be the most practical and preferred implementations, it is to be understood that such detail is solely for that purpose and that the invention is not limited to the disclosed implementations, but, on the contrary, is intended to cover modifications and equivalent arrangements that are within the spirit and scope of the appended claims. For example, it is to be understood that the present invention contemplates that, to the extent possible, one or more features of any implementation can be combined with one or more features of any other implementation.

What is claimed is:

1. A method for unlocking content in a virtual environment based on an aggregated trust level, the method being performed by one or more processors configured to execute computer program instructions, the method comprising:
providing, using one or more processors, content to a first user within the virtual environment, the content comprising views of the virtual environment, the content further comprising non-user characters and a plurality of activities within the virtual environment, the non-user characters including a first non-user character, the non-user characters being grouped into one or more groups of non-user characters, the one or more groups of non-user characters including a first group of non-user characters, the first group of non-user characters including the first non-user character, individual ones of the non-user characters being associated with individual ones of the plurality of activities, and interactions between the first user and the first non-user character including participation by the first user with the first non-user character in an activity in a set of the activities associated with the first non-user character;
determining, using one or more processors, trust levels between individual users and individual non-user characters, wherein the trust level between the first user and the first non-user character is determined based on one or both of a number of interactions or a duration of interactions between the first user and the first non-user character;
determining, using one or more processors, group trust levels between individual users and individual groups of the non-user characters, wherein a group trust level between the first user and the first group of non-user characters is based on an aggregation of the trust level of the first user with the first non-user character and the trust levels of the first user with the other non-user characters in the first group of non-user characters; and
unlocking, using one or more processors, for the first user, content that was previously locked for the first user responsive to the first user achieving a group trust level with the first group of non-user characters that breaches a first group trust threshold.

2. The method of claim 1, wherein the previously locked content that is unlocked for the first user comprises a new non-user character in the virtual environment.

3. The method of claim 1, wherein the content includes a plurality of episodes within the virtual environment, the first user being presented one episode at a time, and wherein the previously locked content that is unlocked for the first user comprises an episode that has not previously been presented to the first user in the virtual environment.

4. The method of claim 1, further comprising providing, to the first user, a privilege associated with the first non-user character in the virtual environment responsive to the trust level associated with the first non-user character or the first group of non-user characters breaching a privilege threshold.

5. The method of claim 1, further comprising prompting the first non-user character to provide a virtual item to the first user responsive to the trust level associated with the first non-user character or the first group of non-user characters breaching a gifting threshold.

6. The method of claim 1, wherein participation by the first user with the first non-user character in one or more activities associated with the first non-user character includes participation by an avatar associated with the first user with the first non-user character in one or more activities associated with the first non-user character.

7. A computer-readable storage medium having instructions embodied thereon, the instructions being executable by a processor to perform a method for unlocking content in a virtual environment based on an aggregated trust level, the method comprising:
providing content to a first user within the virtual environment, the content comprising views of the virtual environment, the content further comprising non-user characters and a plurality of activities within the virtual environment, the non-user characters including a first non-user character, the non-user characters being grouped into one or more groups of non-user characters, the one or more groups of non-user characters including a first group of non-user characters, the first group of non-user characters including the first non-user character, individual ones of the non-user characters being associated with individual ones of the plurality of activities, and interactions between the first user and the first non-user character including participation by the first user with the first non-user character in an activity in a set of the activities associated with the first non-user character;
determining trust levels between individual users and individual non-user characters, wherein the trust level between the first user and the first non-user character is determined based on one or both of a number of interactions or a duration of interactions between the first user and the first non-user character;
determining group trust levels between individual users and individual groups of the non-user characters, wherein a group trust level between the first user and the first group of non-user characters is based on an aggregation of the trust level of the first user with the first non-user character and the trust levels of the first user with the other non-user characters in the first group of non-user characters; and
unlocking, for the first user, content that was previously locked for the first user responsive to the first user achieving a group trust level with the first group of non-user characters that breaches a first group trust threshold.

8. The computer-readable storage medium of claim 7, wherein the previously locked content that is unlocked for the first user comprises a new non-user character in the virtual environment.

9. The computer-readable storage medium of claim 7, wherein the content includes a plurality of episodes within the virtual environment, the first user being presented one episode at a time, and wherein the previously locked content that is unlocked for the first user comprises an episode that has not previously been presented to the first user in the virtual environment.

10. The computer-readable storage medium of claim 7, wherein the method further comprises providing, to the first user, a privilege associated with the first non-user character in the virtual environment responsive to the trust level associated with the first non-user character or the first group of non-user characters breaching a privilege threshold.

11. The computer-readable storage medium of claim 7, wherein the method further comprises prompting the first non-user character to provide a virtual item to the first user responsive to the trust level associated with the first non-user character breaching a gifting threshold.

12. The computer-readable storage medium of claim 7, wherein participation by the first user with the first non-user character in one or more activities associated with the first non-user character includes participation by an avatar associated with the first user with the first non-user character in one or more activities associated with the first non-user character.
